(19) United States
(12) Patent Application Publication
(10) Pub. No.: US 2010/0286176 A1
(43) Pub. Date: Nov. 11, 2010

(54) FLOWERS

(75) Inventors: Marcel Jacobus Maria Hubers, Bergen Op Zoom (NL); Jan Adrianus Mostert, Bergen Op Zoom (NL); Franziscus Hubertus Wagemans, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/513,672

(22) PCT Filed: Oct. 31, 2007
(86) PCT No.: PCT/EP2007/009477

§ 371 Date: Aug. 3, 2010

(30) Foreign Application Priority Data
Nov. 6, 2006 (GB) 0622071.9

(51) Int. Cl. A01N 43/54; A01N 43/64; A01N 43/36; A01P 3/00

(52) U.S. Cl. 514/269; 514/275; 514/383; 514/422

(57) ABSTRACT

The present invention relates to methods for reducing the incidence of Botrytis and improving the shelf life of flowers. In particular, the invention relates to methods for improving the vase life of cut flowers comprising the application of fungicidal compositions. The invention also relates to methods for improving the shelf life of flowering pot plants comprising the application of fungicidal composition. Further, the invention relates to novel fungicidal compositions.

The present invention relates to methods for reducing the incidence of Botrytis and improving the shelf life of flowers. In particular, the invention relates to methods for improving the vase life of cut flowers comprising the application of fungicidal compositions. The invention also relates to methods for improving the shelf life of flowering pot plants comprising the application of fungicidal composition. Further, the invention relates to novel fungicidal compositions.

The worldwide market for cut flowers is estimated to be in the region of $US 70 billion. The market size is growing, and consumers are demanding higher quality flowers that remain fresh for longer. This consumer-driven demand for large volumes of high quality flowers that stay looking fresher for longer is applying pressure throughout the supply chain from suppliers and distributors to growers. Accordingly, in order to satisfy the increasing demand in both volume and quality of cut flowers, it is desirable to both minimise the loss of flowers that is incurred during the supply chain, and maximise the shelf life of flowers.

Several criteria are used to assess the quality of cut flowers, including flower senescence, wilting, leaf yellowing, and abscission and loss of leaves, buds, petals and flowers (shattering). Numerous factors contribute to a loss of quality of cut flowers, and result in poor shelf life. These include poor food or water supply, environmental conditions (temperature, light, humidity), water quality, ethylene, mechanical damage, and microbial contamination and disease. Each of these factors play a role during both transport and storage of the flowers.

When attached to the plant, flowers have a constant source of food in the form of carbohydrates produced by photosynthesis. Cut flowers, however, are devoid of food, hormones and water supply after detachment from the plant, and depend solely on stored food at the time of harvest and the application of exogenous sugars. A lack of water, or inability of the flower to take up water will reduce its vase life. Microorganisms that grow on submerged plant tissue can be taken up into the flower stem, and form a physical blockage (a bacterial plug) to water uptake. Ageing in flowers is directly proportional to the rate of respiration, which is dependent on temperature. Storing flowers in a higher temperature will result in a much shorter vase life for flowers in water. Exposure to ethylene causes premature wilting or shattering of flowers. Mechanical damage, for example caused by rough handling or injury to tissue when cutting flower stems, makes flowers more susceptible to disease, and therefore prone to faster senescence.

A wide range of techniques are already employed today to delay senescence, and improve the shelf life of cut flowers. For example, these include temperature control during shipping, use of novel packaging systems to ensure a availability of good quality water, and use of sugar or biocide-based compositions in vase water.

Chemical treatment of cut flowers after harvest is commonly used to improve shelf life. For example, flowers may be treated with an active ingredient such as 1-MCP to combat ethylene-induced post harvest wilting. Alternatively, treatment of cut flowers with kinetin has been shown to delay senescence of carnations. Treatment of daffodil flowers with silver thiosulphate has also been shown to enhance vase life.

One of the key problems that reduces the shelf life of cut flowers is disease infection. However, few chemical treatments are concerned with reducing the incidence of microbial contamination. The most common solution employed for preventing the incidence of disease in vase water is the use of sugar-biocide mixtures that are supplied with flowers. The purpose of these mixtures is to reduce the onset microbial contamination in the vase water, and provide nutrients for the flowers.

After harvest, flowers are susceptible to infection by bacteria and fungi. The grey mould Botrytis cinerea, is the most common source of disease in cut flowers. Factors that affect Botrytis infection include the availability of conidia on the flowers, the environmental conditions, and the susceptibility of the flowers. Botrytis infection occurs when condensed moisture forms on the surface of flower tissues. Since cut flowers are routinely shipped at temperatures close to freezing point, it is difficult to prevent water condensing on the flower tissues. It is thought that Botrytis infection may be the single biggest factor in reducing vase life. However, few of the existing treatments effectively address the problem of Botrytis infection.

The application of chemical fungicides after harvest, for example by dipping the flower buds into a fungicide solution, has been used to reduce fungal infection for some flower species. However, such treatments leave a fungicide residue on the flower stems and leaves, leading to possible chemical exposure to the consumer. Therefore there exists a need for a method of fungicide treatment that does not leave potentially harmful residues on flower stems. Further, existing treatments are slow and expensive. Therefore there exists a need for a method of Botrytis control in cut flowers that is quick and easy to apply.

Other fungal diseases that are implicated in reducing the vase life of cut flowers include powdery mildew (Sphaerotheca pannosa in roses) and Phytophthora. Both of these diseases attack the plant leaves, and therefore reduce the quality of the stem such that it is undesirable to the consumer.

Given the size of the high-value cut flower market, there exists a need for methods for fungicide treatment that are more effective. Similarly, there is a need for methods of fungicidal treatment that are more effective in protecting flowering pot plants, that are also susceptible to fungicidal disease such as Botrytis, especially during transportation. Further still, due to consumer pressure, there exists a continuing need to further improve the vase life of cut flowers and shelf life of flowering pot plants.

Surprisingly, it has been found that the application of a fungicide to flowering plants that are still in bud, results in a significant improvement in the subsequent incidence of fungal disease on the flowers and in the shelf life of the plants and flowers. In particular, it has been found that the application of a fungicide to plants before harvesting their flowers results in a significant improvement in the subsequent incidence of fungal disease on the flowers after they have been harvested. Further, the application of fungicide to flowering plants pre-shipment results in an improvement in the subsequent incidence of fungal disease on the plants during transport. The pre-harvest or pre-shipment application of a mixture of fludioxonil and cyprodinil has been found to be particularly effective. Further, surprisingly, application of a fungicidal composition to plants before harvesting their flowers, results in an improved vase life of the flowers after they have been harvested. Again, a fungicidal composition comprising fludioxonil and cyprodinil is particularly effective.

Pre-harvest application of fungicide would not be expected to be effective at controlling fungal disease post-harvest, because the flowers are still in bud and so flower petals cannot be coated with protective fungicide, and also because the fungicide needs to keep fungal contamination at bay for longer. Therefore it is truly surprising that a pre-harvest application is so effective at providing post-harvest fungal control in cut flowers.

U.S. Pat. No. 5,519,026 discloses, inter alia, mixtures of fludioxonil and cyprodinil in general, and describes the synergistic action of these two active ingredients when used in combination. It also indicates that the mixture has fungicidal properties that are useful for protecting plants such as vines and fruit trees against Botrytis cinerea. However, it does not relate to control of post-harvest fungal disease. In contrast, the present invention relates to the pre-harvest application of fungicide to provide an improvement in flower vase life post-harvest, and to the pre-shipment treatment of flowering plants to provide a reduction in fungal disease and improvement in plant shelf life during transport. In particular, it relates to the application of fungicide while the flowers are still in bud.

International patent publication WO02/067658 relates to extending the shelf life of berry fruits by pre-harvest treatment of fungicides such as cyprodinil and fludioxonil. The application of fungicides directly to berry fruits on the plant results in a protective layer of fungicide that coats the fruits and consequently provides protection against fungal infection for the berry fruits after harvest. In contrast, the present invention relates to treating closed flower buds or treating flowers before they are harvested from the plant when most of the flowers are still in bud, rather than coating the surfaces of the flower petals. Since the invention is not concerned with treatment with a contact fungicide, it is surprising that it results in good fungal control and improved vase life of the treated flowers.

According to the present invention, there is provided a method for improving the shelf life of flowering plants, comprising applying a fungicidal composition in a fungicidally effective amount, to the flowers when they are in bud.

According to the present invention, there is also provided a method for improving the vase life of cut flowers, comprising applying a fungicidal composition to a flowering plant in a fungicidally effective amount, before harvesting flowers from the plant.

In the context of the present invention, a flowering plant is a plant that is capable of producing flowers. The plant does not necessarily need to be in full flower. Preferably, the flowers of the plant are still developing and/or are in bud.

Any flowering plant may be used in conjunction with the present invention. Examples of common plant species that are used in the cut flower industry include Agapanthus africanus (Lily of the Nile), Alstroemeria, Anemone (Windflower), Anthurium andraeanum (Flamingo Flower), Antirrhinum majus (Snapdragon), Argyranthemum frutescens (Marguerite Daisy/Boston Daisy), Aster (Michaelmas Daisy), Bouvardia, Cattleya (Orchid), Chamelaucium uncinatum (Waxflower), Delphinium, (Larkspur), Dendranthema×grandiflorum (Chrysanthemum), Dianthis caryophyllus (Carnation), Dianthus barbatus (Sweet William), Eustoma grandiflora (Lisianthus/Prairie gentian), Freesia, Gentiana (Gentian), Gerbera jamesonii (Gerbera/Transvaal Daisy), Gladiolus, Gypsophila paniculata (Baby's Breath), Helianthus annuus (Sunflower), Heliconia humilis (Parrot Flower), Iris (Fleur-de-lis), Lathyrus odoratus (Sweet Pea), Liatris spicata Gayfeather, Lilium (Lily/Asiatic Lily/Oriental Lily), Limonium (Statice), Matthiola incana (Stock), Narcissus pseudonarcissus (Daffodil), Oncidium (Orchid), Rosa (Rose e.g. ‘Maroussia!’, ‘Grand Prix’), Solidaster luteus (Yellow Aster), Strelitzia reginae (Bird of Paradise), Tulipa (Tulip), and Zantedeschia aethiopica (Cala lily). Examples of common plant species that are used as flowering pot plants include Phalaenopsis, Anthurium, Kalanchoe, Chrysanthemum, Hydrangea, Spathiphyllum, Lilium, Bromelia, Begonia, Poinsettia, Cyclamen, Azalea, Saintpaulia, Gerbera, Primula, Viola (pansy), Petunia, Begonia, Pelargonium, Osteospermum, Fuchsia, Calluna, Solanum, Erica, Lobelia, Impatiens walleriana, Verbena, Gazania, Dianthus, Salvia, Brassica, Tagetes, Bellis, Hibiscus, Camelia, Phlox, Abutilon, Canna, Cosmos, Bidens, Myosotis, Lantana, Ranunculus, Antirrhinum, Dahlia, Scaevola, Nicotiana, Ageratum, Zinnia, Lavatera, Pentas, Celosia, Nemesia, and Impatiens New Guinea.

In one embodiment, the invention relates to a method for preventing the occurrence, reducing the incidence, or delaying the onset of fungal infection in cut flowers, comprising applying a fungicidal composition to a flowering plant in a fungicidally effective amount, before harvesting flowers from the plant. In a further embodiment, the invention relates to a method for preventing the occurrence, reducing the incidence, or delaying the onset of Botrytis infection in cut flowers, comprising applying a fungicidal composition to a flowering plant in a fungicidally effective amount, before harvesting flowers from the plant.

In a further embodiment, the invention relates to a method for preventing the occurrence, reducing the incidence, or delaying the onset of fungal infection in flowering pot plants, comprising applying a fungicidal composition to the flowering plant in a fungicidally effective amount, while the flowers are still in bud.

Any fungicide having activity against Botrytis may be used in the present invention. For example, the fungicide may be selected from the list consisting of cyprodonil, fludioxonil, bixafen, trifloxystrobin, azoxystrobin, kresoxin-methyl, pyraclostrobin, fluazinam, iprodion, vinclozolin, procymidone, cyproconazole, chlorothalonil, captan, folpel, prochloraz, difenoconazole, tebuconazole, prothioconazole, 3-difluoromethyl-1-methyl-1H-pyrazole-4-carboxylic acid(9-isopropyl-1,2,3,4-tetrahydro-1,4-methano-naphthalen-5-yl)-amide and fungicides from the OPA class.

In one embodiment, the composition comprises at least one fungicide selected from the group consisting of 4-cyclopropyl-6-methyl-N-phenylpyrimidin-2-amine (cyprodinil), 4-(2,2-difluoro-1,3-benzodioxol-4-yl)-pyrrole-3-carbonitrile (fludioxonil), 2-[(2RS)-2-(1-chlorocyclopropyl)-3-(2-chlorophenyl)-2-hydroxypropyl]-2H-1,2,4-triazole-3(4H)-thione (prothioconazole), 2-chloro-N-(4′-chlorobiphenyl-2-yl)nicotinamide (boscalid), 3-difluoromethyl-1-methyl-1H-pyrazole-4-carboxylic acid(9-isopropyl-1,2,3,4-tetrahydro-1,4-methano-naphthalen-5-yl)-amide (compound A) and mixtures thereof.

The vapour activity and systemicity of the fungicide or mixture of fungicides may be important factors in determining whether pre-harvest application of the fungicide will successfully increase the shelf life of flowering plants or vase life of the flowers after harvest.

The composition may comprise two-way mixtures of fungicides such as cyprodinil and fludioxonil, cyprodinil and prothioconazole, cyprodonil and boscalid, fludioxonil and prothioconazole, fludioxonil and boscalid, prothioconazole and boscalid, fludioxonil and compound A, cyprodonil and compound A, azoxystrobin and compound A, difenoconazole and compound A. Alternatively, the composition may comprise three-way mixtures, for example of cyprodonil fludioxonil and prothioconazole, cyprodonil fludioxonil and boscalid, fludioxonil prothioconazole and boscalid, cyprodinil prothioconazole and boscalid, and fludioxonil, cyprodonil and compound A.

In one embodiment, the composition comprises a mixture of fludioxonil and cyprodinil. Fludioxonil is a non-systemic phenylpyrrole fungicide with good residual activity. It is not readily taken up into the plant tissues. Cyprodonil is a broad spectrum systemic anilinopyrimidine fungicide that is taken up into plants after foliar application, and then transported throughout the plant tissue and acropetally in the xylem. Mixtures of cyprodinil and fludioxonil, such as the product Switch®, provide broad spectrum fungal control. Accordingly, the present invention may also be used for control of a range of fungal pests that infect flowers such as Botrytis, Alternaria, Ascochyta, Sclerotinia, Stemphylium, Venturia, Monilinia, Sphaerotheca, Podosphaera, Erysiphe, Leveilulla, Uncinula, Guignardia, Rhizopus, Trichothecium, Colletotrichum, Penicillium, Aspergillus and Glomerella.

In one aspect of the invention, the ratio of fludioxonil to cyprodinil in the mixture is approximately 1:1.5. Preferably, the mixture comprises 250 g/Kg fludioxonil and 375 g/Kg cyprodinil. Typically, the mixture may be used at a concentration of between approximately 0.5 and 200 g/L water. The rate at which the fungicidal composition is applied depends on the mode of application, and the flower species being treated. For example, when spray treating roses, a typical rate of 1500 L/ha may be used. In contrast, when treating the same crop by fogging a rate of 20 L/ha may be employed.

In the production of cut flowers, numerous plants are grown simultaneously in large glasshouses. It is inevitable that there will be some natural variation in the timing of flowering, resulting in a range of flower maturity. Flowers are harvested daily, as the flower buds begin to open. Therefore, when applying a fungicidal composition to flowering plants pre-harvest, most of the flowers will be in bud. However, at any one time, a proportion of the flowers will probably be open. Therefore, in one embodiment, at least 50% of the flowers on the plant are in bud at the time of applying the fungicidal composition. In another embodiment, at least 75% of the flowers on the plant are in bud at the time of applying the fungicidal composition. In further aspects of the invention, at least 10%, 25%, 50%, 60%, 70%, 75%, 80%, 85%, 90% or 95% of the flowers are in bud. In a further aspect of the invention, most of the flowers are in bud. In a still further aspect of the invention, all of the flowers are in bud at the time of applying the fungicidal composition.

In one embodiment, the flowers are harvested between 0 and 14 days after application of the fungicidal composition. In a further embodiment, the flowers are harvested between 0 and 7 days after application of the fungicidal composition. In further aspects of the invention, the flowers are harvested 1, 2, 3, 4, 5, 6, 7, 8, 9, 10, 11, 12, 13 or 14 days after application of the fungicidal composition. In a preferred embodiment, the flowers are harvested approximately 7 days after application of the fungicidal composition.

In one embodiment, the composition is applied once to the plant before harvesting flowers from the plant. In a further embodiment, the composition is applied at least once to the plant before harvesting flowers from the plant. In a further embodiment, the composition is applied to the plant more than once before harvesting flowers from the plant. Typically fungicide treatments are made once per week. In this way, multiple treatments are achieved by treating plants on successive weeks prior to flower harvest. However, a higher frequency of fungicide treatment may be used, for example 2, 3, 4, 5 or more than 5 treatments per week. The invention includes fungicide treatment by any suitable method, such as spray, fog, smoke or drench application. Suitably, the fungicidal composition is applied by spray application.

In one embodiment of the invention, the fungicidal composition is applied to the plant between 2 and 5 times before harvesting flowers from the plant. In a preferred embodiment, the composition is applied to the plant 2 times before harvesting flowers from the plant. In a further aspect of the invention, the composition is applied at least 2 times before harvesting flowers from the plant. In further aspects of the invention, the composition is applied 2, 3, 4, 5, or more than 5 times before harvesting flowers from the plant.

For flowering pot plants, there will also be natural variation in the timing of flowering resulting in a range of flower maturity. Therefore, when applying a fungicidal composition to flowering plants, most of the flowers will be in bud. However, at any one time, a proportion of the flowers will probably be open. Therefore, in one embodiment, at least 50% of the flowers on the plant are in bud at the time of applying the fungicidal composition. In another embodiment, at least 75% of the flowers on the plant are in bud at the time of applying the fungicidal composition. In further aspects of the invention, at least 10%, 25%, 50%, 60%, 70%, 75%, 80%, 85%, 90% or 95% of the flowers are in bud. In a further aspect of the invention, most of the flowers are in bud. In a still further aspect of the invention, all of the flowers are in bud at the time of applying the fungicidal composition.

Suitably, fungicidal treatment of flowering pot plants takes place before they are transported to the distributor or retailer. In one embodiment, the flowering pot plants are transported between 0 and 14 days after application of the fungicidal composition. In a further embodiment, the flowering pot plants are transported between 0 and 7 days after application of the fungicidal composition. In further aspects of the invention, the flowering pot plants are transported 1, 2, 3, 4, 5, 6, 7, 8, 9, 10, 11, 12, 13 or 14 days after application of the fungicidal composition. In a preferred embodiment, the flowering pot plants are transported approximately 7 days after application of the fungicidal composition.

In one embodiment, the composition is applied once before transporting the flowering pot plant. In a further embodiment, the composition is applied at least once before transportation. In a further embodiment, the composition is applied to the plant more than once before transportation. Typically fungicide treatments are made once per week. In this way, multiple treatments are achieved by treating plants on successive weeks prior to plant transportation. However, a higher frequency of fungicide treatment may be used, for example 2, 3, 4, 5 or more than 5 treatments per week. The invention includes fungicide treatment by any suitable method, such as spray, fog, smoke or drench application. Suitably, the fungicidal composition is applied by spray application.

In one embodiment of the invention, the fungicidal composition is applied to the plant between 2 and 5 times before transporting the flowering pot plants. In a preferred embodiment, the composition is applied to the plant 2 times before transporting the plants. In a further aspect of the invention, the composition is applied at least 2 times before transporting the plants. In further aspects of the invention, the composition is applied 2, 3, 4, 5, or more than 5 times before transporting the plants.

An additional fungicide may be present in the composition of the present invention, for example to broaden the spectrum of fungal diseases controlled, or to improve the efficacy of the composition. In one embodiment, the composition further comprises at least one compound selected from the group consisting of methyl(E)-2-{2-[6-(2-cyanophenoxy)pyrimidin-4-yloxy]phenyl}-3-methoxyacrylate (azoxystrobin), 3-chloro-4-[4-methyl-2-(1H-1,2,4-triazol-1-ylmethyl)-1,3-dioxolan-2-yl]phenyl-4-chlorophenyl ether (difenoconazole), methyl N-(methoxyacetyl)-N-(2,6-xylyl)-D-alaninate (mefenoxam/metalaxyl-M), (±)-1-(β-allyloxy-2,4-dichlorophenylethyl)imidazole (imazilil), (RS)-1-p-chlorophenyl-4,4-dimethyl-3-(1H-1,2,4-triazol-1-ylmethyl)pentan-3-ol (tebuconazole), and (2RS,3RS)-1-(4-chlorophenyl)-4,4-dimethyl-2-(1H-1,2,4-triazol-1-yl)pentan-3-ol (paclobutrazole).

In a preferred embodiment, the composition further comprises at least difenoconazole or azoxystrobin.

According to the present invention, there is provided a composition comprising cyprodinil, fludioxonil and difenoconazole in a fungicidally synergistic amount. According to the present invention, there is provided a composition comprising cyprodinil, fludioxonil and azoxystrobin in a fungicidally synergistic amount. According to the present invention, there is provided a composition comprising cyprodinil, fludioxonil and compound A in a fungicidally synergistic amount.

According to the present invention, there is provided a method for improving the vase life of cut flowers, comprising a) applying a first fungicidal composition to a flowering plant at time T1 in a fungicidally effective amount; b) applying a second fungicidal composition to the plant at time T2 in a fungicidally effective amount; c) optionally repeating steps a) and b); and d) harvesting flowers from the plant between 0 and 7 days after the last application of a fungicidal composition. The method of rotating different fungicidal compositions may be useful to provide control against a broader spectrum of fungal pathogens, to minimise the incidence of resistance, and to make more than one fungicide treatment in a week. Times T1 and T2 may be at different times on the same day, on subsequent days, or one or more days apart. Table 1 provides some examples of timings for T1 and T2.

TABLE 1

| Time T1 | Time T2 |
|---|---|
| Day 1 morning | Day 1 afternoon |
| Day 1 | Day 2 |
| Day 1 | Day 3 |
| Day 1 | Day 4 |
| Day 1 | Day 5 |
| Day 1 | Day 6 |
| Day 1 | Day 7 |
| Day 1 | Day 8 |

In one embodiment, the first fungicidal composition comprises fludioxonil and cyprodinil, and the second fungicidal composition comprises compound A and/or boscalid and/or prothioconazole. Other suitable fungicide rotations may also be used in this method in accordance with this invention. For example, the first fungicidal composition may comprise fludioxonil and cyprodinil, and the second fungicidal composition may comprise azoxystrobin. In another example, the first fungicidal composition may comprise fludioxonil and cyprodinil, and the second fungicidal composition may comprise difenoconazole. In a further example, the first fungicidal composition may comprise compound A, and the second fungicidal composition may comprise azoxystrobin.

In one embodiment, at least 50% of the flowers on the plant are in bud at the time of applying the fungicidal composition in accordance with this method. In another embodiment, at least 75% of the flowers on the plant are still in bud at the time of applying the fungicidal composition. In further aspects of the invention, at least 10%, 25%, 50%, 60%, 70%, 75%, 80%, 85%, 90% or 95% of the flowers are in bud. In a further aspect of the invention, most of the flowers are in bud. In a still further aspect of the invention, all of the flowers are in bud.

According to the present invention, there is provided a method for improving the vase life of cut flowers, comprising a) spraying a fungicidal composition comprising fludioxonil and cyprodinil on a flowering plant in a fungicidally effective amount; b) optionally repeating step a); c) applying a fungicidal composition comprising fludioxonil and cyprodinil to the flowering plant in a fungicidally effective amount by fogging; d) optionally repeating step c); and e) harvesting flowers from the plant between 0 and 7 days after the last application of a fungicidal composition. The time interval between each fungicidal treatment is selected in accordance with the species of flowering plant being treated, and the stage of maturity of the plant. In one aspect of the invention, the time interval between each fungicidal treatment is less than 1 day, 1 day, 2 days, 3, days, 4 days, 5, days, 6 days, 7 days or more than 7 days. In a preferred embodiment, the time interval between each fungicidal treatment is approximately 7 days.

In one embodiment, at least 50% of the flowers on the plant are in bud at the time of applying the fungicidal composition in accordance with this method. In another embodiment, at least 75% of the flowers on the plant are still in bud at the time of applying the fungicidal composition. In further aspects of the invention, at least 10%, 25%, 50%, 60%, 70%, 75%, 80%, 85%, 90% or 95% of the flowers are in bud. In a further aspect of the invention, most of the flowers are in bud. In a still further aspect of the invention, all of the flowers are in bud at the time of applying the fungicidal composition.

According to the present invention, there is provided a method for improving the vase life of cut flowers, comprising applying a fungicidal composition comprising fludioxonil and cyprodinil in a fungicidally effective amount to the flowers when they are in bud. The invention extends to the fungicidal treatment of cut flowers that are still in bud after harvest from the plant.

In one embodiment, at least 50% of the flowers are in bud at the time of applying the fungicidal composition in accordance with this method. In another embodiment, at least 75% of the flowers are in bud at the time of applying the fungicidal composition. In further aspects of the invention, at least 10%, 25%, 50%, 60%, 70%, 75%, 80%, 85%, 90% or 95% of the flowers are in bud. In a further aspect of the invention, most of the flowers are in bud. In a still further aspect of the invention, all of the flowers are in bud at the time of applying the fungicidal composition.

According to the present invention, there is provided a method for improving the shelf life of flowering plants, comprising applying a fungicidal composition comprising fludioxonil and cyprodinil in a fungicidally effective amount to the flowers when they are in bud.

### EXAMPLES

### Example 1

### Field Performance of Switch® on Rose ‘Maroussia!’

### 1.1 Trial Design

Trials were designed to test the effect of pre-harvest treatment of the rose ‘Maroussia!’ with Switch® in the greenhouse, on Botrytis infection and vase life.

The following 4 treatments were used:

1 No treatment control
2 Rovral® (iprodione) 0.1%
3 Switch® (fludioxonil+cyprodinil) 0.08%

### Switch® fog

Each treatment was assessed at each of the following harvest time points:

7DAT1 One fungicide application, harvest 7 days after application
7DAT2 2 fungicide applications, harvest 7 days after 2^{nd} application
7DAT3 3 fungicide applications, harvest 7 days after 3^{rd} application
7DAT4 4 fungicide applications, harvest 7 days after 4^{th} application
7DAT5 5 fungicide applications, harvest 7 days after 5^{th} application
14DAT5 5 fungicide applications, harvest 14 days after 5^{th} application

100 stems were harvested for each treatment at each harvest time point. The flowers were bunched and labelled, then subjected to normal grower handling procedures, and transported to auction. Analysis of the flowers then took place at a test centre.

At the test centre, the flowers were wrapped in plastic sheets in bunches of 10 stems, and the bunches placed in a vase containing an aqueous solution containing aluminium sulphate and surfactant. The vase was placed in a container with 5 other vases containing flowers. The containers were subjected to cold storage for 4 days at 8° C. and 60% relative humidity. The containers were placed close together to simulate a stacking cart. These conditions were designed to simulate typical flower transport and storage conditions.

### 1.2 Assessment of Botrytis Infection and Vase Life

The bottom leaves were removed, the stems cut, and the flowers placed in vases containing cut flower food (Chrysal Clear 10 g/L) dissolved in water. Five stems were placed in each vase, and the vases were stored under controlled conditions of 20° C., 60% relative humidity, 12 hours light (1000 Lux) and 12 hours dark. For each treatment at each harvest time point twenty vases (100 flowers) were tested. On day 7, Botrytis infection of all flowers was assessed. Flowers bearing brown Botrytis spots of at least 1 cm in diameter were identified as being infected.

Further, for each treatment at each harvest time point, 4 of the twenty vases were selected at random to assess vase life. The flowers in the selected vases were examined according to VBN standards three times each week.

### 1.3 Trial Results

TABLE 2
Average Botrytis infection per treatment (%)

| Treatment | 7DAT1 | 7DAT2 | 7DAT3 | 7DAT4 | 7DAT5 | 14DAT5 |
|---|---|---|---|---|---|---|
| 1 | 41 | 62 (h) | 65 | 65 | 48 (h) | 84 |
| 2 | 43 (h) | 55 | 60 (h) | 17* | 16.5* | 47* (h) |
| 3 | 17* | 19* | 31* | 37* | 11* | 17* |
| 4 | 83* | 46 | 54 | 16* | 27* | 71 (h) |

(h) High variability in data (data points include extremes of 0% and 100% Botrytis infection)
*Statistically significant (p < 0.05)

TABLE 3
Average (mean) vase life per treatment (days)

| Treatment | 7DAT1 | 7DAT2 | 7DAT3 | 7DAT4 | 7DAT5 | 14DAT5 |
|---|---|---|---|---|---|---|
| 1 | 12.1 (v) | 10.65 | 11.8 | 10.35 | 8.2 | 7.8 |
| 2 | 15.9 | 9.35 | 14.85 | 13.85 | 15.05* | 11.85 (v) |
| 3 | 18.2* | 14.85* | 10.85 | 13.7 | 15.65* | 18.15* |
| 4 | 8.8 (v) | 9.85 | 14.1 | 17.4* | 13.15 | 12.75 (v) |

(v) High variability in data (one or more data points lie more than 40% away from the mean).
*Statistically significant (p < 0.05)

### 1.4 Trial Summary

The data indicates that treatment 3 (Switch® spray) was the best treatment for both reducing Botrytis infection, and improving vase life of roses after harvest. Additionally, the data indicates that treatment 3 produced a longer lasting effect that the other treatments.

### Example 2

### Field Performance of Switch® Under Different Treatment Regimes on Rose ‘Maroussia!’

### 2.1 Trial Design

Trials were designed to test the effect of different pre-harvest treatment regimes and multiple applications of Switch® in the greenhouse on Botrytis infection and vase life of flowers of the rose ‘Maroussia!’ after harvest.

The following 4 treatments were used:

1 No treatment control
2 Switch® 0.08% (6 applications in 6 subsequent weeks)
3 Fungicide rotation: Switch® 0.08% (2 applications), then Ortiva® 0.08% (2 applications), then Switch® 0.08% (2 applications)
4 Multiple application methods: Switch® spray 0.08% (2 applications), then Switch® fog (4 applications)

Each treatment was assessed at each of the following harvest time points:

7DAT1 One fungicide application, harvest 7 days after application
7DAT2 2 fungicide applications, harvest 7 days after 2^{nd} application
7DAT3 3 fungicide applications, harvest 7 days after 3^{rd} application
7DAT4 4 fungicide applications, harvest 7 days after 4^{th} application
7DAT5 5 fungicide applications, harvest 7 days after 5^{th} application
7DAT6 6 fungicide applications, harvest 7 days after 6^{th} application
14DAT6 6 fungicide applications, harvest 14 days after 6^{th} application

Flowers were harvested and treated in the same way as described in Example 1. Further, assessment of Botrytis infection was performed in the same way as in Example 1.

### 2.2 Trial Results

TABLE 4
Average Botrytis infection per treatment (%)

| Treatment | 7DAT1 | 7DAT2 | 7DAT3 | 7DAT4 | 7DAT5 | 7DAT6 | 14DAT6 |
|---|---|---|---|---|---|---|---|
| 1 | 96 | 67 (h) | 94 | 56 | 59 (h) | 82 | 95 |
| 2 | 74 (h) | 46 (h) | 75* (h) | 42 (h) | 35 | 48* (h) | 74* |
| 3 | 59 (h) | 32 | 57* | 43 (h) | 51 (h) | 49* (h) | 58* (h) |
| 4 | 66 | 31 | 69* | 15* | 54 (h) | 62 (h) | 88 |

(h) High variability in data (data points include extremes of 0% and 100% Botrytis infection)
*Statistically significant (p < 0.05)

TABLE 5
Average (mean) vase life per treatment (days)

| Treatment | 7DAT1 | 7DAT2 | 7DAT3 | 7DAT4 | 7DAT5 | 7DAT6 | 14DAT6 |
|---|---|---|---|---|---|---|---|
| 1 | 6.45 | 8.9 | 4.05 | 9.4 | 8.65 | 7.6 | 5.1 (v) |
| 2 | 6.75 | 9.15 | 11.65* | 12.8 | 10.9 | 7.2 | 8.0 |
| 3 | 6.95 | 12.1 | 8.8* | 12.9 | 10.2 | 10.45 | 7.9 (v) |
| 4 | 8.4 | 11.4 | 7.6 (v) | 15.35* | 10.55 | 10.95 | 7.3 (v) |

(v) High variability in data (one or more data points lie more than 40% away from the mean).
*Statistically significant (p < 0.05)

### 2.3 Trial Summary

There was a fairly high level of variation in both Botrytis infection and vase life for all treatments at all time points. This variation may be caused by differences in natural Botrytis infection, differences in the amount of fungicide received by each flower, differences in the micro climate around individual flowers, and/or differences in flower sensitivity.

Despite the variation, however, the data indicates that all treatments reduced Botrytis infection at all time points. Further, all the treatments resulted in a better vase life than flowers of the control. Notably, the vase life data for treatments 2 and 3 at time point 7DAT3, and treatment 4 in time point 7DAT4 was found to be statistically significant (p<0.05). Overall, pre-harvest treatment of flowers with Switch® (fludioxonil/cyprodinil mixture—treatment 2) reduced Botrytis infection and improved vase life. Further, pre-harvest treatment of flowers using a fungicide rotation of Switch and Ortiva® (azoxystrobin) also reduced Botrytis infection and improved vase life.

### Example 3

### Field Performance of Various Fungicides on Rose ‘Maroussia!’

### 3.1 Trial Design

Trials were designed to test the effect of different fungicides applied to the rose ‘Maroussia!’ pre-harvest in the greenhouse, on Botrytis infection.

The following treatments were used:

### 1 Control

2 Switch® (fludioxonil+cyprodinil) 0.08%
3 Ortiva® (azoxystrobin) 0.08%
4 Score® (difenoconazole) 0.035%
5 Score® (difenoconazole) 0.07%
6 Switch® 0.08%+Score® (difenoconazole) 0.035%

Each treatment was assessed at each of the following harvest time points:

7DAT1 One fungicide application, harvest 7 days after application
7DAT2 2 fungicide applications, harvest 7 days after 2nd application
7DAT3 3 fungicide applications, harvest 7 days after 3rd application
14DAT3 3 fungicide applications, harvest 14 days after 3rd application

Flowers were harvested and treated in the same way as described in Example 1. Further, assessment of Botrytis infection was performed in the same way as in Example 1.

### 3.2 Trial Results

TABLE 6
Average Botrytis infection per treatment (%)

| Treatment | 7DAT1 | 7DAT2 | 7DAT3 | 14DAT3 |
|---|---|---|---|---|
| 1 | 83 | 75 | 83 | 55 |
| 2 | 78 | 54 | 63 | 57 |
| 3 | 82 | 61 | 78 | 40 |
| 4 | 97 | 79 | 84 | 45 |
| 5 | 90 | 64 | 78 | 57 |
| 6 | 62 | 45 | 61 | 26 |

### 3.3 Trial Summary

The results indicate that the pre-harvest application of fungicide results in a lower incidence of Botrytis infection in cut flowers after harvest. In particular, two or more pre-harvest applications of fungicide results in good reductions in Botrytis infection. Further, treatment with mixtures of Switch® (fludioxonil and cyprodinil) and Score® (difenoconazole) (treatment 6) results in particularly good levels of Botrytis control.

### Example 4

### Field Performance of Switch® on Various Rose Varieties

### 4.1 Trial Design

Trials were designed to test the effect of Switch® applied to six different rose varieties (Grand Prix, Aqua!, Maroussia!, Artemis, Cinderella and Avalanche) pre-harvest in the greenhouse, on Botrytis infection. For variety ‘Grand Prix’, roses were tested from three different growers.

The following treatments were used:

### 1 Control

2 Switch® (fludioxonil+cyprodinil) 0.08%

Each treatment was assessed at each of the following harvest time points:

7DAT1 One fungicide application, harvest 7 days after application
7DAT2 2 fungicide applications, harvest 7 days after 2nd application
7DAT3 3 fungicide applications, harvest 7 days after 3rd application

Flowers were harvested and treated in the same way as described in Example 1, except that only 4 vases (20 stems) were tested in each treatment. Further, assessment of Botrytis infection was performed in the same way as in Example 1.

### 4.2 Trial Results

TABLE 7
Average Botrytis infection per treatment (%)

| | 7DAT1 | | 7DAT2 | | 7DAT3 | |
|---|---|---|---|---|---|---|
| Variety | Control | Treated | Control | Treated | Control | Treated |
| Grand Prix (1) | 55.4 | 36.7 | 40.0 | 25.0 | 3.3 | 3.3 |
| Grand Prix (2) | 0.0 | 0.0 | 0.0 | 0.0 | 0.0 | 0.0 |
| Grand Prix (3) | 5.0 | 0.0 | 6.7 | 0.0 | 1.7 | 1.7 |
| Aqua! | 0.0 | 0.0 | 0.6 | 0.0 | nd | nd |
| Maroussia! | 68.3* | 38.3* | 61.7* | 23.3* | 53.3* | 8.3* |
| Artemis | 8.8* | 0.0* | 23.3 | 12.1 | 21.7 | 6.7 |
| Cinderella | 0.0 | 0.0 | 0.0 | 0.0 | 31.7* | 10.0* |
| Avalanche | 20.0 | 11.7 | 28.3* | 1.7* | 36.7* | 1.7* |

nd = no data
*Statistically significant (p < 0.05)

TABLE 8
Average (mean) vase life per treatment (days)

| | 7DAT1 | | 7DAT2 | | 7DAT3 | |
|---|---|---|---|---|---|---|
| Variety | Control | Treated | Control | Treated | Control | Treated |
| Grand Prix (1) | 8.7 | 12.3 | 7.7* | 13.9* | 8.0 | 8.3 |
| Grand Prix (2) | 13.9 | 16.3 | 17.7 | 16.3 | 17.1 | 18.1 |
| Grand Prix (3) | 11.8 | 11.6 | 5.8 | 5.7 | 8.6 | 10.2 |
| Aqua! | 7.3 | 8.5 | 12.7* | 7.0* | nd | nd |
| Maroussia! | 6.7* | 8.1* | 6.5* | 9.9* | 6.8* | 9.9* |
| Artemis | 19.8* | 24.9* | 12.4 | 14.5 | 16.2 | 16.7 |
| Cinderella | 5.7 | 6.2 | 8.1* | 10.0* | 8.1 | 6.4 |
| Avalanche | 10.7 | 9.9 | 8.5 | 9.3 | 11.9 | 14.3 |

nd = no data
*Statistically significant (p < 0.05)

### 4.3 Trial Summary

The results indicate that reduced incidence of Botrytis infection in cut flowers after harvest, following treatment with Switch® pre-harvest, is observed in all six rose species tested. The results also show that, for most varieties at most data points, the vase life of treated flowers is better than that of untreated flowers. Some variability is inevitable. The only notable exception was observed in variety ‘Aqua!’, in which the vase life of the treated flowers at 7DAT2 was less than that of the untreated flowers. This is probably an anomalous result due to variability in the data, and the small sample size.

1. A method for improving the shelf life of flowering plants, comprising applying a fungicidal composition in a fungicidally effective amount, to the flowers when they are in bud.

2. A method according to claim 1, wherein the composition comprises at least one fungicide selected from the group consisting of 4-cyclopropyl-6-methyl-N-phenylpyrimidin-2-amine (cyprodinil), 4-(2,2-difluoro-1,3-benzodioxol-4-yl)-pyrrole-3-carbonitrile (fludioxonil), 2-[(2RS)-2-(1-chlorocyclopropyl)-3-(2-chlorophenyl)-2-hydroxypropyl]-2H-1,2,4-triazole-3(4H)-thione (prothioconazole), 2-chloro-N-(4′-chlorobiphenyl-2-yl)nicotinamide (boscalid), 3-difluoromethyl-1-methyl-1H-pyrazole-4-carboxylic acid(9-isopropyl-1,2,3,4-tetrahydro-1,4-methano-naphthalen-5-yl)-amide and mixtures thereof.

3. A method according to claim 2, wherein the composition comprises a mixture of fludioxonil and cyprodinil.

4. A method according to claim 1, wherein at least 50% of the flowers on the plant are in bud at the time of applying the fungicidal composition.

5. A method according to claim 4, wherein at least 75% of the flowers on the plant are still in bud at the time of applying the fungicidal composition.

6. A method according to claim 1, wherein the flowers are harvested from the plant after application of the fungicidal composition.

7. A method according to claim 6, wherein the flowers are harvested between 0 and 7 days after application of the fungicidal composition.

8. A method according to claim 7, wherein the flowers are harvested approximately 7 days after application of the fungicidal composition.

9. A method according to claim 6, wherein the composition is applied to the plant more than once before harvesting flowers from the plant.

10. A method according to claim 9, wherein the composition is applied to the plant between 2 and 5 times before harvesting flowers from the plant.

11. A method according to claim 10, wherein the composition is applied to the plant 2 times before harvesting flowers from the plant.

12. A method according to claim 1, wherein the composition is applied by spray application.

13. A method for improving the vase life of cut flowers, comprising:
a) applying a first fungicidal composition to a flowering plant at time T1 in a fungicidally effective amount,
b) applying a second fungicidal composition to the plant at time T2 in a fungicidally effective amount,
c) optionally repeating steps a) and b), and
d) harvesting flowers from the plant between 0 and 7 days after the last application of a fungicidal composition.

14. A method according to claim 13, wherein the first fungicidal composition comprises fludioxonil and cyprodinil, and the second fungicidal composition comprises 3-difluoromethyl-1-methyl-1H-pyrazole-4-carboxylic acid(9-isopropyl-1,2,3,4-tetrahydro-1,4-methano-naphthalen-5-yl)-amide and/or boscalid and/or prothioconazole.

15. A method for improving the vase life of cut flowers, comprising:
a) spraying a fungicidal composition comprising fludioxonil and cyprodinil on a flowering plant in a fungicidally effective amount,
b) optionally repeating step a),
c) applying a fungicidal composition comprising fludioxonil and cyprodinil to the flowering plant in a fungicidally effective amount by fogging,
d) optionally repeating step c), and
e) harvesting flowers from the plant between 0 and 7 days after the last application of a fungicidal composition.

16. A method according to claim 13, wherein at least 50% of the flowers on the plant are in bud at the time of applying the last fungicidal composition before the flowers are harvested.

17. A method according to claim 2, wherein the composition further comprises at least one compound selected from the group consisting of methyl(E)-2-{2-[6-(2-cyanophenoxy)pyrimidin-4-yloxy]phenyl}-3-methoxyacrylate (azoxystrobin), 3-chloro-4-[4-methyl-2-(1H-1,2,4-triazol-1-ylmethyl)-1,3-dioxolan-2-yl]phenyl-4-chlorophenyl ether (difenoconazole), methyl N-(methoxyacetyl)-N-(2,6-xylyl)-D-alaninate (mefenoxam/metalaxyl-M), 2-chloro-N-(4′-chlorobiphenyl-2-yl)nicotinamide (boscalid), (±)-1-(β-allyloxy-2,4-dichlorophenylethyl)imidazole (imazilil), (RS)-1-p-chlorophenyl-4,4-dimethyl-3-(1H-1,2,4-triazol-1-ylmethyl)pentan-3-ol (tebuconazole), 2-[(2RS)-2-(1-chlorocyclopropyl)-3-(2-chlorophenyl)-2-hydroxypropyl]-2H-1,2,4-triazole-3(4H)-thione (prothioconazole) and (2RS,3RS)-1-(4-chlorophenyl)-4,4-dimethyl-2-(1H-1,2,4-triazol-1-yl)pentan-3-ol (paclobutrazole).

18. A method according to claim 17, wherein the additional compound is difenoconazole.

19. A composition comprising cyprodinil, fludioxonil and difenoconazole in a fungicidally synergistic amount.

20. A method according to claim 17, wherein the additional fungicidal compound is azoxystrobin.

21. A composition comprising cyprodinil, fludioxonil and azoxystrobin in a fungicidally synergistic amount.

22. A composition comprising cyprodonil, fludioxonil and 3-difluoromethyl-1-methyl-1H-pyrazole-4-carboxylic acid(9-isopropyl-1,2,3,4-tetrahydro-1,4-methano-naphthalen-5-yl)-amide in a fungicidally effective amount.

23. A method for improving the vase life of cut flowers, comprising applying a fungicidal composition comprising fludioxonil and cyprodinil in a fungicidally effective amount to the flowers when they are in bud.

24. A method for improving the shelf life of flowering plants, comprising applying a fungicidal composition comprising fludioxonil and cyprodinil in a fungicidally effective amount to the flowers when they are in bud.
